(19) United States
(12) Patent Application Publication
(10) Pub. No.: US 2008/0305377 A1
(43) Pub. Date: Dec. 11, 2008

(54) LONG METALLIC NANOWIRES, METHODS OF MAKING, AND USE THEREOF IN PROTON EXCHANGE MEMBRANE FUEL CELL

(75) Inventors: Jianglan SHUI, Rochester, NY (US); James C.M. LI, Pittsford, NY (US)

Correspondence Address: NIXON PEABODY LLP - PATENT GROUP, 1100 CLINTON SQUARE, ROCHESTER, NY, 14604, US

(73) Assignee: UNIVERSITY OF ROCHESTER, Rochester, NY (US)

(21) Appl. No.: 12/049,723

(22) Filed: Mar. 17, 2008

Related U.S. Application Data
(60) Provisional application No. 60/895,043, filed on Mar. 15, 2007.

(51) Int. Cl. H01M 4/86; H05B 6/00; H01M 8/10; D01D 5/00; D06M 10/00; B01J 21/18

(52) U.S. Cl. 429/30; 264/433; 428/397; 429/44; 425/174.8 E

(57) ABSTRACT

A method and apparatus for making a metallic nanofiber structure are disclosed. The method includes the steps of: providing a first solution including a first material and a second material, wherein the second material includes at least one metal; forming the first solution into composite fibers including the first material and the second material; and removing the first material from the composite fibers under conditions effective to produce a metallic nanofiber structure that includes a plurality of metallic nanofibers. Also disclosed are metallic nanofiber structures prepared according to a process of the present invention, which can be used as fuel cell catalysts. Fuel cells containing electrodes that include these metallic nanofiber structures are also disclosed.

This application claims the priority benefit of U.S. Provisional Patent Application Ser. No. 60/895,043, filed Mar. 15, 2007, which is hereby incorporated by reference in its entirety.

### FIELD OF THE INVENTION

The present invention relates to the preparation of long metallic nanowire (nanofiber) structures, methods of making the same by electrostatic spinning techniques, and use thereof in the fabrication of proton exchange membrane (PEM) fuel cells.

### BACKGROUND OF THE INVENTION

Platinum has a widespread use in many applications. For example, it is a major catalyst in the synthesis of nitric acid, reduction of pollutant gases emitted from automobiles, oil cracking, PEM fuel cells (Rouxoux et al., Chem. Rev. 102:3757 (2002); Williams et al., Catal. Today 38:401 (1997)) and many others. To obtain a high surface area per unit mass, nanoparticles have been prepared by chemical methods (Narayanan et al., Nano Lett. 4:1343 (2004); Falicov et al., Proc. Natl. Acad. Sci. USA 82:2207 (1985)).

In PEM fuel cells, the catalyst is prepared typically by embedding the platinum nanoparticles in a carbon support. This construction, however, lacks sufficient durability, which has largely prevented widespread commercialization of PEM fuel cells. In PEM fuel cells with flowing water, over time the platinum nanoparticles are lost from the carbon support. It is believed that significant electrochemical oxidation of the carbon support and the shifting of Pt nanoparticles could be the root cause of platinum loss (Shao et al., J. Electrochem. Soc. 153(6):A1093-A1097 (2006); Stevens et al., Carbon 43:179-188 (2005); Xie et al., J. Electrochem. Soc. 152(1):A104-A113 (2005); Shao et al., J Power Sources 171:558-566 (2007)). Therefore, it would be desirable to overcome these deficiencies of carbon-supported platinum nanoparticle catalysts.

Catalyst films without carbon support have larger space available for gas transportation, thus increasing the rate of diffusion between the gaseous phase and the electrode. However, not much work has been reported on the one-dimensional (1D) nanostructure of platinum. Some studies using templates reported success in producing platinum nanorods and nanotubes (Teranishi et al., J. Phys. Chem. B 103:3818-3827 (1999); Chen et al., J. Phys. Chem. B 105:5397-5401 (2001); Wakayama et al., Adv. Mater. 15:742-745 (2003); Teng et al., Nano Lett. 3:261-264 (2003); Ahmadi et al., Science 272:1924-1925 (1996)), but the templates have to be removed later and the length of the metallic nanorod or nanotubes is restricted by the template. Recently, however, Chen et al. (Small 11: 1340-1343 (2006)) described the growth of platinum nanorods and nanowires via polyol reduction of spherical aggregates of platinum nanoparticles in the presence of a trace amount of iron species. However, the length of the nanowires fabricated by Chen et al. was little more than 500 nm, which is insufficient to form a stable interconnected catalyst material. In addition, the polyol reduction synthesis is time consuming.

While Bognitzki et al., Adv. Mater. 18:2384-2386 (2006) describes the formation of a copper microwire structure by electrospinning processes, the average fiber diameter is much larger than 100 mm and such a size is too large for use as a catalyst in a PEM fuel cell.

Therefore, it would be desirable to identify an efficient process for forming interconnected metal nanofiber structures that can be used as a catalyst in a PEM fuel cell to overcome the above-noted deficiencies of carbon-supported PEM fuel cell catalysts.

The present invention is directed to overcoming these and other deficiencies in the art.

### SUMMARY OF THE INVENTION

A first aspect of the present invention relates to a method of making a metallic nanofiber structure. The method includes the steps of: providing a first solution including a first material and a second material, wherein the second material includes at least one metal; forming the first solution into composite fibers including the first material and the second material; and removing the first material from the composite fibers under conditions effective to produce a metallic nanofiber structure that includes a plurality of metallic nanofibers.

A second aspect of the present invention relates to a metallic nanofiber structure prepared according to the present invention. The metallic nanofiber structures of the present invention are characterized by an average fiber diameter of less than about 100 nm and an average fiber length of at least about 1 μm.

Preferred metallic nanofiber structures of the present invention include a plurality of interconnected metallic nanofibers, and have an average fiber diameter less than about 50 nm, and an average fiber length of at least about 10 μm. Metallic nanofiber structures having fiber lengths in excess of 1 mm are described herein.

A third aspect of the present invention relates to a catalyst for a fuel cell that includes a metallic nanofiber structure according to the present invention. The catalyst may optionally contain a carbon-based material.

A fourth aspect of the present invention relates to an electrode for a fuel cell that includes a metallic nanofiber structure according to the present invention. The electrode can be used as either an anode or a cathode.

A fifth aspect of the present invention relates to a fuel cell that includes an electrode of the present invention. The fuel cell is preferably a PEM fuel cell.

A sixth aspect of the present invention relates to an electrospinning apparatus that includes: a container that contains a solution including a polymer and a first metal salt; an orifice in fluid communication with the container; a surface that confronts the orifice; and a power supply coupled to the orifice and the surface, thereby forming an electric field across the region between the orifice and the surface, whereby discharge of the solution from the orifice into the electric field results in a first composite polymer/metal salt fiber formed on the surface.

Because the metallic nanofiber structures of the present invention include interconnected nanofibers (nanowires) less than 100 nm in diameter, and even as small as several nanometers, but with lengths up to several millimeters, the metallic nanofiber structures of the present invention are characterized by high surface area and high durability. In addition, metallic nanofiber structures tested to date have proven to be much more efficient than E-TEK 20% catalyst, particularly at voltages less than about 0.8 V. Given their mechanical stability, the catalysts of the present invention do not require the presence of a carbon support, which overcomes the problems of carbon corrosion and platinum particle aggregation. The metallic nanofiber structures should afford more efficient PEM fuel cells, which are less expensive to produce.

### BRIEF DESCRIPTION OF THE DRAWINGS

FIG. 1 is a schematic view of an electrostatic spinning apparatus.

FIG. 2 illustrates the construction of a fuel cell containing a seven-layer membrane electrode assembly (MEA). The sealing gasket and gas diffusion layers are shown together to simplify the illustration. One or both of the electrodes include a metallic nanofiber structure of the present invention as catalyst.

FIGS. 3A-B are scanning electron micrograph (SEM) images of the PVP and H₂PtCl₆ composite fibers made by electrospinning. Composite fiber dimensions are noted in FIG. 3A.

FIG. 4 is a graph illustrating X-ray diffraction patterns of final Pt fibers and PtNi₃ fibers.

FIGS. 5A-D are SEM images of Pt fibers made by a manufacturing process of the present invention. FIGS. 5C-D are enlargements corresponding to portions of FIG. 5A-B, respectively. Pt fiber dimensions are noted in FIGS. 5C-D.

FIG. 6 is a transmission electron micrograph (TEM) image of a Pt fiber made by the manufacturing process of the present invention.

FIG. 7 is a TEM image of a Pt nanofiber structure of the present invention after 5 minutes of sonic oscillation in water.

FIG. 8 is a graph of a voltage-amp curve of a Pt nanofiber structure of the present invention. The measurements were made in 0.1M H₂SO₄/1M ethanol. As shown, a current density of ˜30 mA/mg_{(Pt)} was observed.

FIG. 9 is an SEM image of a PtNi₃ alloy nanofiber structure made by the manufacturing process of the present invention.

FIG. 10 is a TEM image of a PtNi₃ fiber made by the manufacturing process of the present invention.

FIG. 11 is a graph illustrating the performance of an MEA that includes a Pt nanofiber structure of the present invention as catalyst (MEA2) versus an MEA that includes a commercial Pt/C particle catalyst (MEA1). Current density was normalized per milligram Pt of cathode.

FIG. 12 is a graph illustrating the performance of MEA1 (Pt/C particle catalyst) and MEA2 (Pt nanofiber catalyst). Current density was normalized per unit area of Pt cathode.

FIG. 13 is a schematic illustration of an electrostatic spinning system for spinning of two different types of composite fibers simultaneously. This setup can produce a metallic nanofiber structure that includes two or more types of metallic fibers.

FIGS. 14A-B are SEM images of an interconnected structure containing Pt nanofibers and Cu microfibers, made by a manufacturing process of the present invention. FIG. 14B is an enlargement corresponding to portions of FIG. 14A. Dimensions of Pt nanofibers are noted in FIG. 14B.

### DETAILED DESCRIPTION OF THE INVENTION

The present invention concerns metallic nanofiber structures that include a plurality of interconnected metallic nanofibers (or nanowires), methods and apparatuses for fabricating the same, and use thereof as catalysts on an electrode of a fuel cell.

The metallic nanofiber structure is characterized by an interconnected web of metallic nanofibers. As used herein, the terms “nanofiber” and “nanowire” can be used interchangeably to describe the metallic fibers produced as components of the metallic nanofiber structure of the present invention. These structures are characterized by having an average fiber diameter that is less than about 100 nm. The average fiber diameter can be calculated by measuring substantially all fiber diameters in one SEM image (containing sparsely dispersed fibers), and then determining the average diameter for the assessed structure. Preferred metallic nanofiber structures are those having an average fiber diameter that is less than about 50 nm, more preferably within a range of about 2 nm to about 30 nm, most preferably about 2 nm to about 10 nm. The nanofibers or nanowires can vary widely in length. Within these preferred metallic nanofiber structures, the average fiber length is at least about 1 μm, more preferably at least about 10 μm, and most preferably at least about 100 μm. Metallic nanofiber structures having fiber lengths in excess of 1 mm are described herein. The average fiber length can be calculated by measuring substantially all fiber lengths in one SEM image (containing sparsely dispersed fibers), and determining the average diameter for the assessed structure.

The metallic nanofiber structures of the present invention are prepared using a solution that includes a first material and a second material, wherein the second material includes at least one metal. Basically, the solution is formed into composite fibers including the first material and the second material, and then the first material is removed from the composite fibers under conditions effective to produce the metallic nanofiber structure. The metallic nanofiber structure can include nanofibers that are substantially pure metal, or the nanofibers can be metal alloys, depending upon the second material that is used.

The first material preferably includes a polymer. Any polymer material capable of being drawn into fiber form and then removed from the composite fibers can be employed in the present invention. Exemplary polymers include, but are not limited to, poly(ethylene oxide), poly(vinylidene fluoride), polyvinyl alcohol, polyvinyl acetate, and polyvinylpyrrolidone. The first material is preferably present in the solution at a concentration of about 1 to about 100 mg/ml, more preferably about 2 to about 50 mg/ml, most preferably about 5 to about 25 mg/ml.

The second material includes one or more compounds selected from the group consisting of a metallic salt and an organometallic salt. The metal component of the salt can be any metal, but is preferably platinum, titanium, chromium, manganese, molybdenum, vanadium, cobalt, zinc, tin, iron, nickel, copper, gallium, zirconium, hafnium, ruthenium, rhodium, iridium, palladium, osmium, tungsten, gold, silver, or alloys containing one or more of these metals as well as other metals. Specific alloys include, without limitation, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, and Pt/Ru/Sn/W. Preferred metals or metal alloys are those which are efficient for use as catalysts in PEM fuel cells.

Substantially pure metal nanofibers can be formed using salts of a single metal, whether present as a single metal salt or as multiple metal salts. Alloys can be formed using salts of two or more metals; one or more salts of each type of metal can be used.

Suitable metallic salts include, but are not limited to, H₂PtCl₆, NiCl₂, Ni(NO₃)₂, HAuCl₄, RuCl₃, SnCl₂, MoCl₃, PdCl₂, FeCl₂, CrCl₃, Co(NO₃)₂, WCl₃, and H₃VO₄. Suitable organometallic salts include, but are not limited to, Pt(C₅H₇O₂)₂, Pt(NH₂dmoc)₄(PtCl₄), and WCl₂(OC₂H₅)₃.

The second material is preferably present in the solution at a concentration of about 1 to about 100 mg/ml, more preferably about 2 to about 50 mg/ml, most preferably about 5 to about 25 mg/ml.

The solution may further include one or more solvents including, without limitation, water, alcohols such as methanol, ethanol, isopropanol, etc., or mixtures thereof.

A preferred approach for forming the composite fibers is electrostatic spinning (or electrospinning). Electrostatic spinning has been known for decades and has proven to be a very good method for producing ultrathin polymer fibers (Li et al., Adv. Mater. 16:1151-1170 (2004); Reneker et al., Nanotech. 7:216-223 (1996); Frenot et al., Curr. Opin. Colloid Interf. Sci. 8:64-75 (2003); Huang et al., Compos. Sci. Technol. 63:2223-2253 (2003); Subbiah et al., J. Appl. Polym., Sci. 96:557-569 (2005), each of which is hereby incorporated by reference in its entirety). The technique uses high voltage to pull a conical solution jet, and then the jet is developed into a very thin, uniform, and long nanofiber in a very short time.

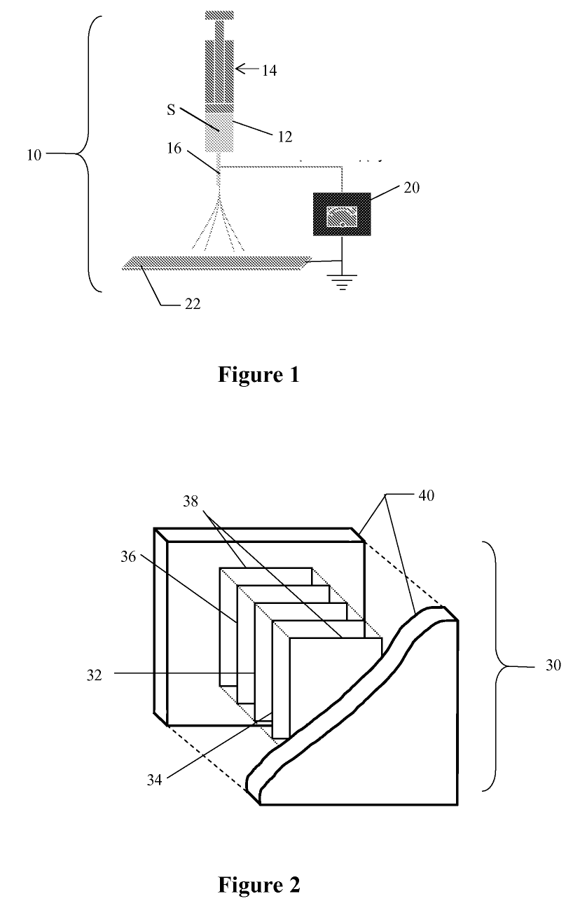

An exemplary electrostatic spinning system 10 is illustrated in FIG. 1. The system includes a reservoir 12 (that contains the solution S) and pump mechanism 14 that ensures delivery of a suitable flow of the solution to the electrospray nozzle 16. The nozzle 16 is electrically coupled to a high-voltage power supply 20, which creates a high potential between the nozzle 16 and the collector substrate 22.

The collector substrate 22 optionally can be mounted to a rotational mechanism. The substrate can be mounted to the surface of a spinning disk, which itself is mounted on a vertical rotating shaft. High voltage is applied between the disk and a metallic support on the back of the receiving sheet. The disk can translate vertically to deliver the fibers on the substrate, where the composite fibers can be removed at intervals and new composite fiber products can be produced.

Any suitable electrostatic spinning conditions can be used to form the composite fibers. Preferably, the electrostatic spinning is carried out under an electric field of about 0.1 to about 5 kV/cm, more preferably 0.5 to about 3 kV/cm, most preferably about 0.5 to about 2.5 kV/cm. Exceptional results have been obtained in the range of about 0.5 to about 2 kV/cm.

The distance between the nozzle 16 and the substrate 22 can be adjusted depending on the voltage per unit distance. Higher voltages per unit distance usually result in a thinner fiber, but too high voltage can result in discontinuity of the electrospinning process. Preferably, the distance is between about 30 to about 200 mm.

After forming the composite fibers, the first material is removed therefrom to form the metallic nanofiber structure of the present invention. Removal of the first material can be carried out by thermally decomposing the first material.

Thermal decomposition conditions can vary depending on the nature of the first material which is to be removed. Preferably, this is achieved by heating the composite fibers at a suitable temperature in air, an inert atmosphere (e.g., nitrogen), or in a reducing atmosphere (e.g., H₂/Ar).

To the extent the second material is formed of a metallic or organometallic salt, the thermal decomposition conditions should also be effective to decompose both the organic components and the salt components.

Thermal decomposition is preferably carried out at temperatures in the range of from about 340° C. up to about 800° C. Excellent results have been achieved in the range of about 340° C. up to about 500° C.

After removal of the first material, and any organic or salt components of the second material, the metallic nanofiber structure is formed.

In addition, where alloy nanofibers are prepared, it may be desirable to treat the alloy nanofibers under conditions effective to remove at least a portion of one or more of the alloyed metals from the nanofibers, thereby forming a substantially pure metallic nanofiber structure or a metallic nanofiber having a reduced content of a particular metal. For example, acid treatments can be used to remove certain metals, such as HCl treatment of PtNi₃ alloy fibers to dissolve Ni from the surface of these fibers.

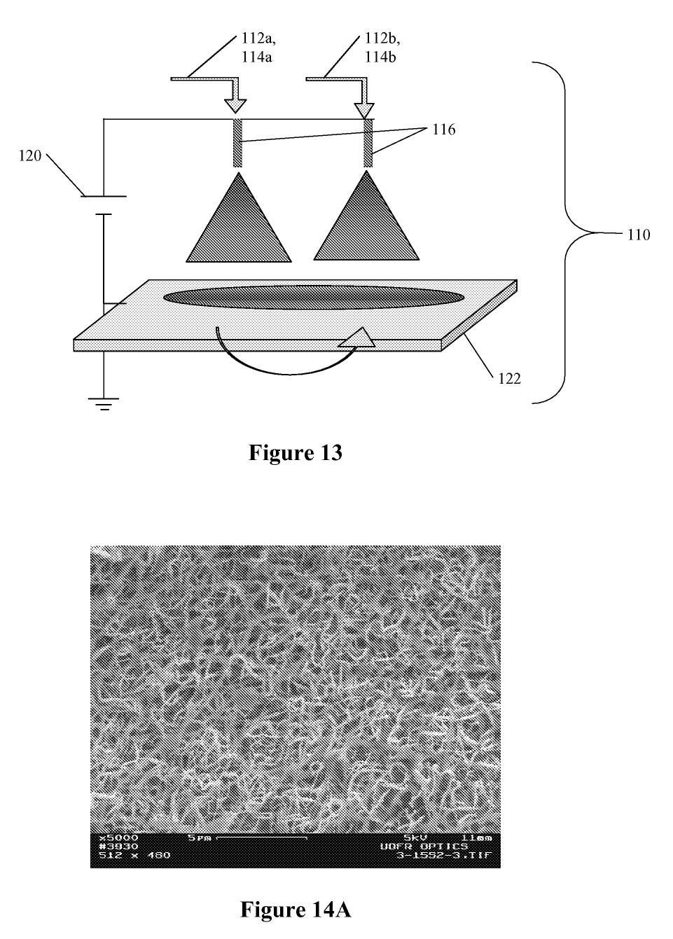

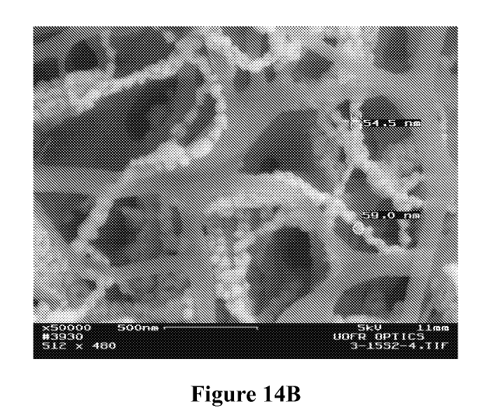

A second exemplary electrostatic spinning system 110 is illustrated in FIG. 13. The system includes a pair of reservoirs 112a,b (that contain the solutions and pump mechanisms 114a,b that ensure delivery of a suitable flow of the solutions to the respective electrospray nozzles 116. The nozzles 116 are electrically coupled to a high-voltage power supply 120, which creates a high potential between the nozzle 116 and the collector substrate 122. The collector substrate 122 is coupled to a rotational mechanism so that the substrate can be rotated during spraying. The electrospray conditions can be the same as those described above.

Although two nozzles are shown, it should be appreciated that any number of nozzles can be utilized. In addition, if desired, the electric field can be varied for each nozzle to tailor the size of the resulting nanofibers.

This type of electrostatic spraying system is designed to produce a metallic nanofiber structures that include two different types of fibers (or more, depending on the numbers of available nozzles). At least one of these fibers is a nanofiber, and the others can be nanofibers or microfibers (i.e., having average fiber diameters between 100 nm and about 1 μm). In addition, the different fiber types can be formed of the same metal or different metals; the metals can be substantially pure or alloys as described above.

Whether the metallic nanofiber structure is formed of a single type of fiber or multiple types of fibers, the resulting metallic nanofiber structure can optionally be modified by introducing one or more additives to the structure.

According to one embodiment, the additive is a carbon-based material that is introduced into the nanofiber structure. Exemplary carbon-based materials include, without limitation, graphite, denka black, ketjen black, acetylene black, carbon nanotubes, carbon nanofiber, carbon nanowire, carbon nanoballs, activated carbon, etc. These can be introduced after forming the metallic nanofiber structure or during the electrospinning process (i.e., using the set up shown in FIG. 13).

According to another embodiment, the additive can be an inorganic material. Exemplary inorganic materials include, without limitation, particulates such as alumina, silica, zirconia, titania, etc. These can be introduced after forming the metallic nanofiber structure or during the electrospinning process (i.e., using the set up shown in FIG. 13).

The metallic nanofiber structure of the present invention can be used as a catalyst for any of a variety of chemical reactions, including as a catalyst in a PEM fuel cell.

Thus, a further aspect of the present invention relates to an electrode for a fuel cell that contains a metallic nanofiber structure of the present invention. The electrode preferably includes the metallic nanofiber structure and a suitable ionomer. The metallic nanofiber structure to ionomer weight ratio is preferably about 2:1 up to about 10:1, more preferably about 2:1 up to about 7:1, most preferably about 3:1 to about 4:1.

The overall dimension of each electrode is preferably between about 2 to about 10 μm, although deviations from this range are possible as long as the electrode remains permeable to proton transfer.

A number of suitable ionomers are known in the art and can be used to fabricate the electrode of the present invention. Suitable ionomers include, without limitation, fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. Exemplary ionomers include, without limitation, poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole). One preferred ionomer is commercially available under the tradename NAFION® (available from E. I. du Pont de Nemours Co.)

Electrode fabrication using the ionomer(s) and metallic nanofiber structure can be carried out using standard procedures. Basically, the ionomer and metallic nanofiber structure are combined, optionally with a carbon-based material (described above), and if necessary ultrasonically mixed to ensure adequate distribution of the ionomer and carbon-based materials between the nanofibers. These materials are coated onto a conductive substrate (e.g., carbon paper, carbon cloth, carbon felt, etc.), and then the electrodes can be hot pressed on either side of a proton exchange membrane.

A number of suitable proton exchange membranes are known in the art and can be utilized in fabricating the electrodes and MEAs of the present invention. Preferred proton exchange membranes are NAFION® membranes, which are available from E.I. du Pont de Nemours Co. in various dimensions. Other manufactured MEAs include polybenzimidazole (PBI) membranes available from Celanese AG and BASF Fuel Cell, Inc., and PRIMEA® MEAs (available from W.L. Gore & Associates).

Once the electrodes are fabricated, they can be used to assemble an MEA of a PEM fuel cell. The basic construction of the PEM fuel cell 30 is illustrated in FIG. 2. The seven layer MEA includes a central proton exchange membrane 32 flanked on opposite sides by an anode catalyst layer 34 and a cathode catalyst layer 36, all of which are sandwiched between a pair of gas diffusion layers/current collectors that are sealed with a gasket, collectively denoted 38. The MEA is positioned between a pair of end plates 40, one of which directs the flow of hydrogen over the anode catalyst, and the other of which directs the flow of oxygen (air) over the cathode catalyst and concomitant removal of water therefrom. The end plates are provided with channels through which the fluids flow.

In one embodiment, both the anode and cathode catalyst layers are formed using the metallic nanofiber structure of the present invention.

In another embodiment, the cathode catalyst layer is formed using the metallic nanofiber structure of the present invention and the anode catalyst layer includes any other conventional catalyst material suitable for use as the anode.

Any suitable gas diffusion layer (GDL) can be employed in the MEA of the present invention. Known GDLs include, without limitation, water-proofed carbon paper coated with a hydrophilic diffusion layer (for anode side) or hydrophobic diffusion layer (for cathode side). Conventional coating materials include PTFE and TEFLON®.

The end plates are typically formed of machined aluminum or stainless steel, although for purposes of reducing the weight of the overall fuel cell stack, polymer materials can also be used. For example, end plates formed of FORTRON® polyphenylene sulfide (PPS) or CELSTRAN® PPS-glass fiber (GF) are available from Celanese AG (Dallas, Tex.). These materials satisfy the requirements of structural rigidity even at temperatures well in excess of the operating temperatures of the fuel cell.

Although a seven-layer MEA is illustrated in FIG. 2, it should be appreciated that any MEA design can be fabricated using the electrode of the present invention. This includes five-layer MEAs.

### EXAMPLES

The following examples are provided to illustrate embodiments of the present invention but are by no means intended to limit its scope.

### Example 1

### Electrospinning Setup

The setup for electrospinning has been described previously (Li et al., Adv. Mater. 16:1151-1170 (2004), which is hereby incorporated by reference in its entirety), and is illustrated schematically in FIG. 1. The set up includes a high voltage supplier (Dongwen, Tienjing, China), a syringe pump (Harvad Pump 11, USA), and a plastic syringe equipped with a 22 gauge needle made of stainless steel. Carbon paper was used to collect the fibers. The carbon paper and needle were coupled to the high voltage supplier as shown.

The syringe pump was filled with a solution including a polymer precursor material and one or more metal salts, and upon injection of the solution across the DC electric field, composite nanofibers were formed. The parameters for formation of specific composite fibers and their use to form substantially pure metal or alloy nanofibers are described in the subsequent examples.

### Example 2

### Fabrication of Long Nanowires of Metallic Platinum by Electrospinning

In the instant experiment, high molecular weight poly(vinyl pyrrolidone) (PVP) (molecular weight: 1300000) and chloroplatinic acid hydrate (H₂PtCl₆) with H₂O and C₂H₅OH were selected to make the precursor solution. Through electrostatic spinning, H₂PtCl₆,/PVP composite nanofibers were obtained. Heating the composite nanofibers at high temperatures removed PVP, H⁺, and Cl⁻, where the metallic platinum long fibers were left behind. The fiber diameter and length can be tailored by adjusting the composition of the precursor solution and the spinning parameters, with higher concentrations yielding thicker diameter fibers and lower concentrations yielding thinner diameter fibers. The precursor solution composition and spinning parameters used in the instant experiment are listed in Table 1 below.

TABLE 1
Range of Precursor Solution Composition
and Other Spinning Parameters

| | |
|---|---|
| PVP concentration (mg/ml) | 10~50 |
| H₂PtCl₆•6H₂O (mg/ml) | 10~50 |
| H₂O/C₂H₅OH (v/v) | 0.05~0.3 |
| Voltage (kV/cm) | 0.5~2 |
| Jet to substrate distance (cm) | 3~20 |
| Sintering temperature (° C.) | 340~800 |
| Atmosphere | Air or inert gas |

The best results (i.e., thinnest fibers) made to date were achieved with the following conditions shown in Table 2:

TABLE 2
Precursor Solution Composition and Other Spinning Parameters

| | |
|---|---|
| PVP concentration (mg/ml) | 17.5 |
| H₂PtCl₆•6H₂O (mg/ml) | 12.5 |
| H₂O/C₂H₅OH (v/v) | 0.2 |
| Voltage (kV/cm) | 1.4 |
| Jet to substrate distance (cm) | 5 |
| Sintering temperature (° C.) | 380 |
| Atmosphere | Air |

The resulting composite fiber structures and metallic nanofiber structures were examined by SEM, TEM, and X-ray diffraction to assess the properties of the structures, including content and fiber dimensions.

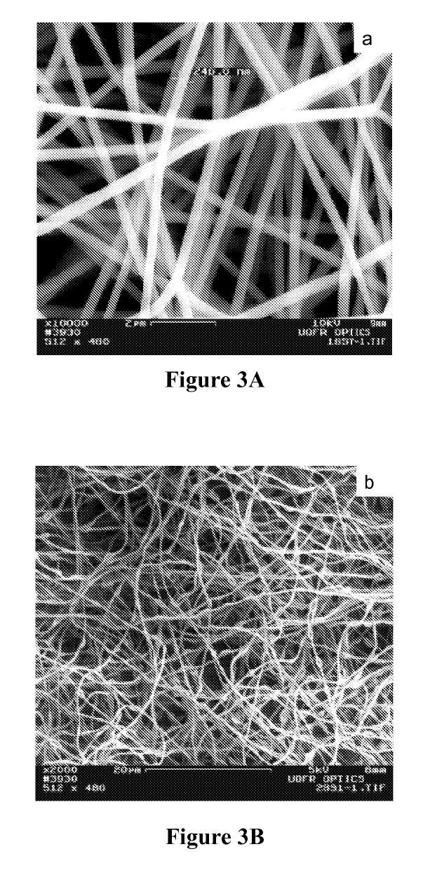

FIGS. 3A-B show the morphologies of the PVP/H₂PtCl₆ composite fibers. The composite fibers have larger diameters than the final platinum fibers, because they contain other major components, such as PVP and Cl. The fibers were straight and smooth when the PVP concentration was high in the precursor solution, as shown in FIG. 3A; otherwise, the fibers were more curved when the PVP concentration was lower, as shown in FIG. 3B.

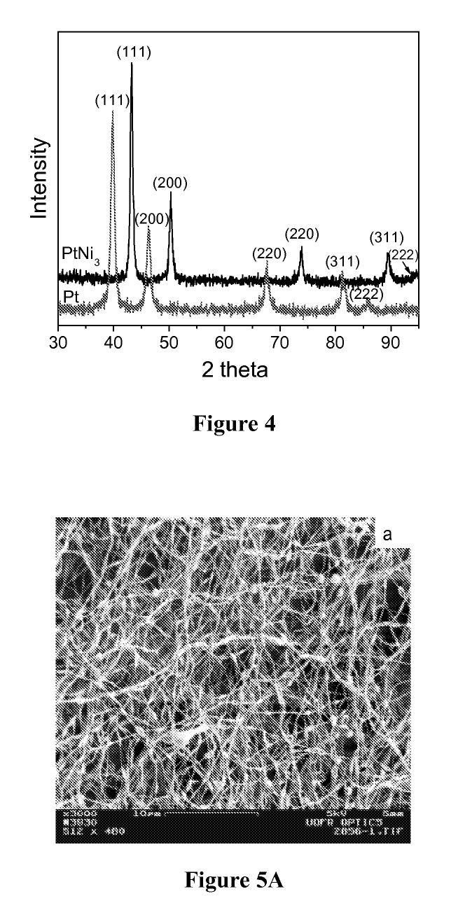

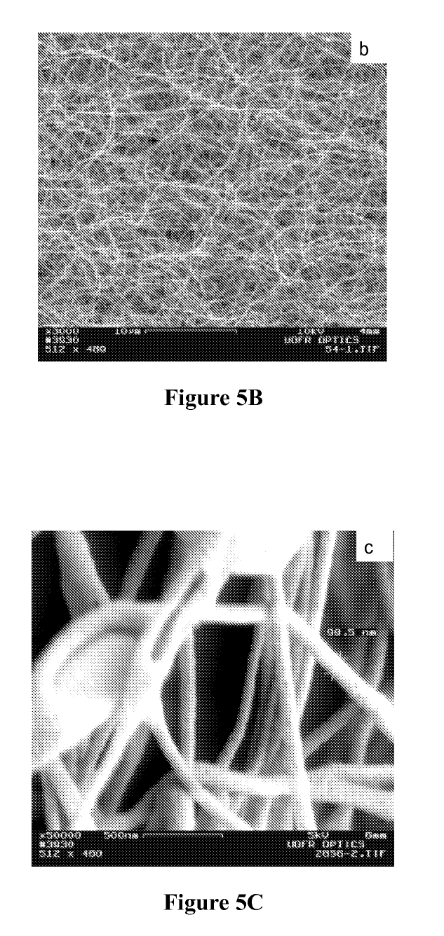

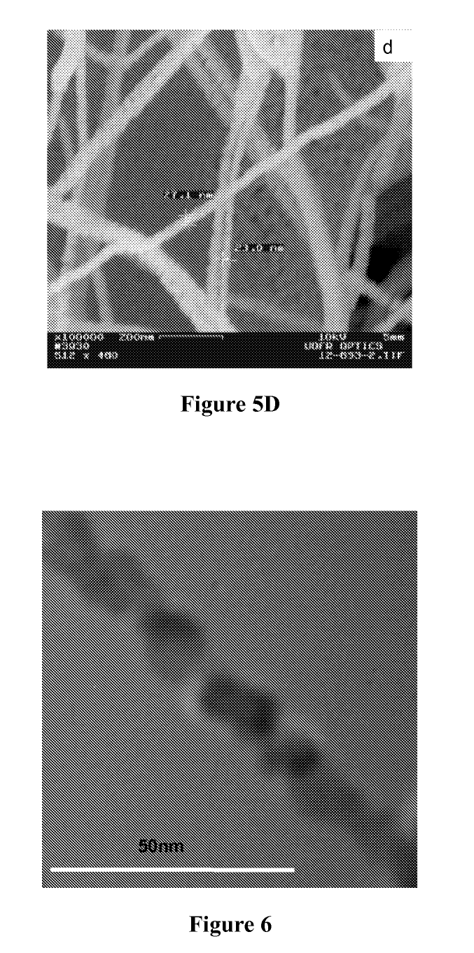

After heating in air at 380° C., the composite fibers decomposed and only the platinum metal was left behind. The obtained nanowire was pure platinum as confirmed by the X-ray diffraction pattern shown in FIG. 4. The platinum takes the form of its precursor, namely the fiber. The length of the fiber was estimated to be several millimeters long. A number of pure platinum fibers were measured, and proved to have diameters as thick as 100 nm (FIGS. 5A, 5C) or as thin as about 23 nm (FIGS. 5B, 5D). The final diameter of the fiber is controllable by adjusting the solution composition and spinning speed, which is controlled by both the voltage and the pump rate.

The fibers were not smooth, but instead composed of platinum grains, as can be seen more clearly in the TEM picture (FIG. 6). It also could be taken as a string of platinum nanoparticles. With this structure, every particle can expose at least half of its surface area. Using platinum nanoparticles as catalyst usually requires inserting platinum particles into some type of support material, such as carbon black. Thus, in typical catalysts, a steady inlaid particle has only about half of its surface area exposed. This suggests that the platinum nanofibers prepared according to the present invention should supply an effective surface area as compared to nanoparticles with the same radius.

FIGS. 5A, 5B also show some leaf shaped structures at spaced locations along the length of individual fibers. This is a common phenomenon in electrostatic spinning. While several authors have described approaches to avoid formation of these leaf-shaped structures (Fong et al., Polymer 40:4585-4592 (1999); Lee et al., Polymer 44:4029-4034 (2003), each of which is hereby incorporated by reference in its entirety), it is believed their presence is desirable in the nanofiber materials of the present invention, because these leaf-shaped structures can supply high surface areas.

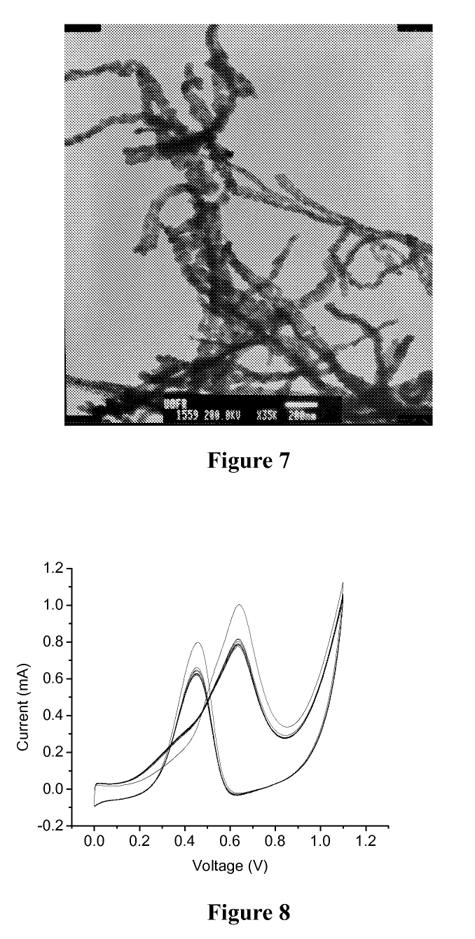

To check the platinum fiber mechanical strength, several platinum nanofiber structures were introduced into a bottle of water and subjected to sonic oscillation. After several minutes of sonic oscillation, the fiber structures were found to be maintained without breaking of the fibers into particles (FIG. 7), showing that the connecting strength of the fibers between platinum grains is fairly strong.

### Example 3

### Fabrication of Long Nanowires of Metallic Platinum/Nickel Alloy by Electrospinning Technique

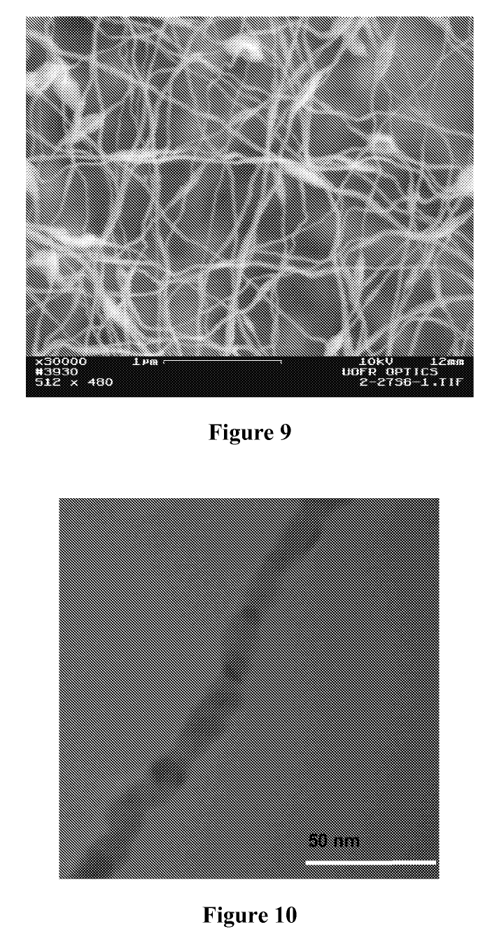

The solution for PtNi₃ alloy nanofibers included H₂PtCl₆ (˜15 mg/ml), NiCl₂ (˜14.5 mg/ml), and polyvinylpyrrolidone (PVP) (˜16 mg/ml) dissolved in ethanol/water (81:19 volume ratio). After electrostatic spinning using a pump rate of 0.3 ml/hr and electric field of 7 kv/5 cm, composite fibers were obtained. Heating the composite nanofibers at 340° C./air/10 min, then at 500° C./(H₂/Ar)/30 min produced the PtNi₃ alloy nanofibers. The obtained alloy nanowire was confirmed by the X-ray diffraction pattern shown in FIG. 4. FIGS. 9A-B are SEM and TEM images of PtNi₃ alloy nanofiber.

### Example 4

### Preparation of Membrane Exchange Assemblies (MEAs)

To make a comparison of electrochemical performance between Pt nanofiber structures and conventional Pt/C particles as catalysts, two kinds of MEAs were prepared using the hot press method. Each MEA had an active area of 5 cm². The catalysts used in this work were E-TEK (20%), containing conventional Pt/C particles, and the Pt nanofibers produced in the manner described in Example 2. The MEA was a seven-layer structure.

The gas diffusion layer (GDL) for the anode catalyst layer was water-proofed carbon paper coated with a hydrophilic diffusion layer, and the GDL for the cathode catalyst layer was water-proofed carbon paper coated with a hydrophobic diffusion layer. The hydrophilic diffusion layer for the anode comprised Vulcan XC-72 carbon black and 30 wt. % of NAFION® ionomer (DuPont), and the hydrophobic diffusion layer for the cathode comprised Vulcan XC-72 carbon black and 20 wt. % of PTFE. GDL with PTFE needed heat treatment at 350° C. for 30 minutes. The loading of carbon black was about 1 mg/cm² for both the anode and the cathode. The E-TEK™ (20 wt. % Pt) catalyst powder and 5 wt. % NAFION® ionomer solution were ultrasonically mixed in isopropyl alcohol to form a homogeneous catalyst ink. The NAFION® content in both the anode and the cathode catalyst layers were 25 wt. %.

For MEA1, the catalyst ink was scraped onto the hydrophobic (hydrophilic) diffusion layers to form the cathode (anode) electrodes. The Pt metal loading was 0.4 mg/cm² for the cathode electrode, and 0.3 mg/cm² for the anode electrode.

For MEA2, the anode was the same as that used in MEA1. The cathode was composed of Pt nanofiber (80 wt. %) and NAFION® ionomer (20 wt. %), and the Pt loading was 1 mg/cm². The cathode and anode were hot pressed on either side of a piece of NAFION® membrane (DuPont 115) separately with pressure 1001 b/cm² at 130° C. for 120 s.

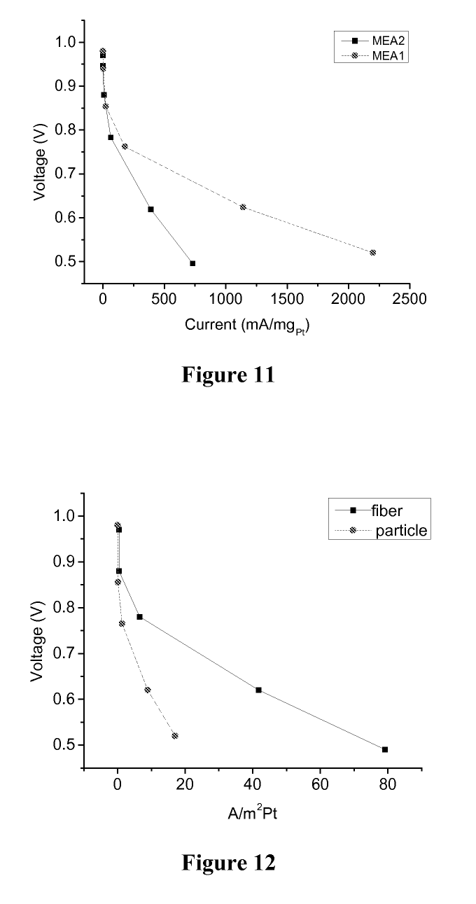

Electrochemical performance was tested in a homemade PEMFC fixture. Pure dry oxygen and hydrogen were supplied into the cell at ambient pressure. Data were collected after 4 hours activation operation. The lower current density for Pt fiber is because of its bigger size and lower surface area compared with commercial Pt/C particle catalyst (FIG. 11).

One the other hand, the average diameter of the Pt fiber is about 20 nm. With a density of 21.45 g/cm³, the surface area per unit mass is 9.3 m² per gram. The surface area of E-TEK™ 20% catalyst is 128 m²/g (according to the manufacturer). Thus, in replotting FIG. 11 using mA per unit area rather than per unit mass, it can be seen that the platinum nanofiber electrode is far more efficient in terms of current per unit area (FIG. 12). In other words, there are nanoparticles in the E-TEK™ electrode that are not being used as effectively as the nanofibers of the inventive electrode. Further reductions in fiber diameter should improve the current density and further enhance the efficiency.

### Example 5

### Dual Electrospinning Setup

The setup for dual electrospinning is illustrated schematically in FIG. 13. The set components are substantially the same as those used in Example 1 for the electrospinning of a single fiber type, except that two nozzles (one for each solution) are employed and the carbon paper was mounted on a rotatable surface. During the electrospinning process, the surface was rotated at 30 rpm.

The syringe pump was filled with a solution including a polymer material and one or more metal salts, and upon injection of the solution across the DC electric field, composite nanofibers were formed. The parameters for formation of specific composite fibers and their use to form substantially pure metal or alloy nanofibers is described in the subsequent examples.

### Example 6

### Fabrication of Platinum Nanowires Mixed with Copper Microwires by Dual Electrospinning Technique

A setup of the type described in Example 5 was used to electrospin a mixed wire structure that contains both Pt nanowires and Cu microwires. In this setup, one syringe spins H₂PtCl₆/PVP nanowires and the other spins CuCl₂/PVP microwires using the conditions shown in Table 3 below.

TABLE 3
Precursor Solution Composition and Other Spinning Parameters

| H₂PtCl₆/PVP nanowires | | CuCl₂/PVP microwires | |
|---|---|---|---|
| PVP concentration (mg/ml) | 25 | PVP concentration (mg/ml) | 30 |
| H₂PtCl₆•6H₂O (mg/ml) | 20 | CuCl₂ (mg/ml) | 30 |
| H₂O/C₂H₅OH (v/v) | 0.15 | H₂O/C₂H₅OH (v/v) | 0.1 |
| Voltage (kV/cm) | 1.0 | Voltage (kV/cm) | 1.0 |
| Jet to substrate distance | 5 | Jet to substrate distance | 5 |
| (cm) | | (cm) | |

The resulting mixture of composite wires was heat treated at 340° C./air/10 min, then at 500° C./H₂/10 min.

The mixed metal fiber structure was designed to increase the electronic conductivity of the whole film. Because the resistance of Pt nanowires is fairly high (R≈1/r²), the introduction of thicker Cu microwires should allow more favorable transfer of electrons to the Pt nanofibers. While Cu may not be stable enough in commercial fuel cells, a fuel cell containing this mixture will be prepared (i.e., as described in Example 4) to assess the electronic conductivity of this catalyst film.

### Example 7

### Introduction of Carbon-Based Material to Platinum Nanowire Structures

Platinum nanofiber structures will be mixed with carbon nanotubes or carbon microfiber using the setup for dual electrospinning that is described in Example 5, but the CuCl₂/PVP solution will be replaced with a carbon nanotube suspension in PVP. The conditions employed during electrospinning will be same, but subsequent heat treatment will be carried out only in air (as reducing conditions will not be needed).

A fuel cell containing the carbon-modified Pt nanowire structure will be prepared (i.e., as described in Example 4) to assess the electronic conductivity of this catalyst film.

Although the invention has been described in detail, for the purpose of illustration, it is understood that such detail is for that purpose and variations can be made therein by those skilled in the art without departing from the spirit and scope of the invention which is defined by the following claims.

What is claimed:

1. A method of making a metallic nanofiber structure, said method comprising:
providing a first solution comprising a first material and a second material, wherein said second material comprises at least one metal;
forming said first solution into composite fibers comprising the first material and the second material; and
removing the first material from the composite fibers under conditions effective to produce a metallic nanofiber structure comprising a plurality of metallic nanofibers.

2. The method according to claim 1, wherein the first material comprises a polymer.

3. The method according to claim 2, wherein the polymer is selected from the group consisting of poly(ethylene oxide), poly(vinylidene fluoride), polyvinyl alcohol, polyvinyl acetate, polyvinylpyrrolidone, and combinations thereof.

4. The method according to claim 1, wherein the at least one metal in the second material is selected from the group consisting of platinum, titanium, chromium, manganese, molybdenum, vanadium, cobalt, zinc, tin, iron, nickel, copper, gallium, zirconium, hafnium, ruthenium, rhodium, iridium, palladium, osmium, tungsten, gold, silver.

5. The method according to claim 4, wherein the at least one metal is platinum.

6. The method according to claim 1, wherein the second material comprises one or more compounds selected from the group consisting of a metallic salt and an organometallic salt.

7. The method according to claim 6, wherein the metallic salt is selected from the group consisting of H₂PtCl₆, NiCl₂, Ni(NO₃)₂, HAuCl₄, RuCl₃, SnCl₂, MoCl₃, PdCl₂, FeCl₂, CrCl₃, Co(NO₃)₂, WCl₃, and H₃VO₄.

8. The method according to claim 6, wherein the organometallic salt is selected from the group consisting of Pt(C₅H₇O₂)₂, Pt(NH₂dmoc)₄(PtCl₄), and WCl₂(OC₂H₅)₃.

9. The method according to claim 1, wherein said forming is carried out by electrostatic spinning.

10. The method according to claim 9, wherein said electrostatic spinning is carried out using a solution comprising about 1 to about 100 mg/ml of the first material and about 1 to about 100 mg/ml of the second material.

11. The method according to claim 9, wherein said electrostatic spinning is carried out under an electric field of about 0.1 to about 5 kV/cm.

12. The method according to claim 1, wherein said removing the first material comprises heating the composite fibers under conditions effective to decompose the first material.

13. The method according claim 12, wherein said heating is carried out in an inert atmosphere, air, or reducing atmosphere.

14. The method according to claim 12, wherein the composite fibers comprise a metallic salt or an organometallic salt.

15. The method according to claim 14, wherein said heating is carried out a temperature effective to decompose both the organic components and salt components.

16. The method according to claim 12, wherein said heating is carried out at a temperature of about 340° C. to about 800° C.

17. The method according to claim 1, wherein the second material comprises two or more metal salts, and the metallic nanofibers are formed of a metal alloy comprising at least two metals.

18. The method according to claim 17, wherein the metal alloy comprises Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, or Pt/Ru/Sn/W.

19. The method according to claim 17 further comprising:
treating the metallic nanofiber structure obtained following said removing under conditions effective to remove one or more of said at least two metals from the plurality of metallic nanofibers.

20. The method according to claim 1 further comprising:
providing a second solution comprising a third material and a fourth material, wherein said fourth material comprises at least one metal;
wherein said forming further comprises forming said second solution into second composite fibers comprising the third material and the fourth material; and
wherein said removing further comprises removing the third material from the second composite fibers under conditions effective to produce the metallic nanofiber structure that further comprises a second plurality of metallic fibers interconnected with the plurality of metallic nanofibers.

21. The method according to claim 20 wherein the second plurality of metallic fibers are nanofibers.

22. The method according to claim 20 wherein the plurality of metallic nanofibers and the second plurality of metallic fibers are formed of different metals.

23. A metallic nanofiber structure prepared according to the process of claim 1.

24. A metallic nanofiber structure prepared according to the process of claim 20.

25. A metallic nanofiber structure comprising a plurality of metallic nanofibers, and having an average fiber diameter of less than about 100 nm, and an average fiber length of at least about 1 μm.

26. The metallic nanofiber structure according to claim 25, wherein the metallic nanofiber is a substantially pure metal nanofiber.

27. The metallic nanofiber structure according to claim 26, wherein the metallic nanofiber is a platinum nanofiber.

28. The metallic nanofiber structure according to claim 26, wherein the metal is platinum, titanium, chromium, manganese, molybdenum, vanadium, cobalt, zinc, tin, iron, nickel, copper, gallium, zirconium, hafnium, ruthenium, rhodium, iridium, palladium, osmium, tungsten, gold, or silver.

29. The metallic nanofiber structure according to claim 25, wherein the metallic nanofiber is a metal alloy nanofiber.

30. The metallic nanofiber structure according to claim 29, wherein the metal alloy is Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, or Pt/Ru/Sn/W.

31. The metallic nanofiber structure according to claim 25, wherein the plurality of metallic nanofibers comprise first metallic nanofibers formed of one metal or metal alloy and second metallic fibers formed of a different metal or metal alloy.

32. The metallic nanofiber structure according to claim 31, wherein the second metallic fibers are nanofibers.

33. A catalyst material comprising the metallic nanofiber structure according to claim 25.

34. The catalyst material according to claim 25 further comprising a carbon-based material in combination with the metallic nanofiber structure.

35. The catalyst material according to claim 34, wherein the carbon-based material comprises graphite, denka black, ketjen black, acetylene black, carbon nanotubes, carbon nanofiber, carbon nanowire, carbon nanoballs, carbon nanoparticles, or activated carbon.

36. An electrode for a fuel cell comprising the metallic nanofiber structure according to claim 25.

37. The electrode according to claim 36 further comprising an ionomer.

38. The electrode according to claim 36 wherein the weight ratio of metallic nanofiber structure to ionomer is between about 2:1 up to about 10:1.

39. A fuel cell comprising the electrode according to claim 36.

40. The fuel cell according to claim 39, wherein the fuel cell is a proton exchange membrane fuel cell.

41. An electrospinning apparatus comprising:
a chamber comprising a solution that includes a polymer and a first metal salt;
an orifice in fluid communication with the chamber;
a surface that confronts the orifice; and
a power supply coupled to the orifice and the surface, thereby forming an electric field across the region between the orifice and the surface,
whereby discharge of the solution from the orifice into the electric field results in a first composite polymer/metal salt fiber formed on the surface.

42. The electrospinning apparatus according to claim 41 further comprising:
a second chamber comprising a second solution that includes a polymer and a second metal salt; and
a second orifice in fluid communication with the second chamber, wherein the power supply is coupled to the second orifice and the surface,
whereby discharge of the second solution from the orifice into the electric field results in a second composite polymer/metal salt fiber.

43. The electrospinning apparatus according to claim 42, wherein the second metal salt is different from the first metal salt.
